(19) United States
(12) Patent Application Publication
(10) Pub. No.: US 2016/0356235 A1
(43) Pub. Date: Dec. 8, 2016

(54) FUEL DELIVERY CONTROL BASED ON ENGINE SPEED FLUCTUATIONS

(71) Applicant: PINNACLE ENGINES, INC., San Carlos, CA (US)

(72) Inventors: Michael Anthony Willcox, San Carlos, CA (US); Brede Kolsrud, San Carlos, CA (US); James M. Cleeves, Redwood City, CA (US)

(21) Appl. No.: 15/177,331

(22) Filed: Jun. 8, 2016

Related U.S. Application Data
(60) Provisional application No. 62/172,746, filed on Jun. 8, 2015.

(51) Int. Cl. F02D 41/26; F02P 5/15; F02D 41/00

(52) U.S. Cl. CPC F02D 41/263; F02D 41/0077; F02P 5/1504; F02D 2200/101; F02D 2400/02; F02D 2400/04

(57) ABSTRACT

A programmable processor receives engine speed data for an engine. The programmable processor calculates a work corresponding to a component of the engine. The calculated work is based on a change in the engine speed data over a range. A predicted work value is read from a table based on an engine speed and first metric. A value is transmitted to a control system when the calculated work is not the predicted work value. The value, when implemented by the control system, reduces a difference between the predicted work value and the calculated work for the component.

### CROSS-REFERENCE TO RELATED APPLICATIONS

The current application is related to/claims priority under 35 U.S.C. §119(e) to Provisional Patent Application No. 62/172,746, filed Jun. 8, 2015, the contents of which are hereby incorporated by reference in its entirety.

### TECHNICAL FIELD

The subject matter described herein relates to control approaches for internal combustion engines.

### BACKGROUND

Internal combustion engines can be controlled by monitoring, for example, rotations per minute (RPM), airflow, piston pressures, and the like. Engine performance can be adjusted based on sensor measurements from components of the engine or elsewhere in the vehicle.

### SUMMARY

In one aspect, a programmable processor receives engine speed data for an engine. The programmable processor calculates a work corresponding to a component of the engine. The calculated work is based on a change in the engine speed data over a range. A predicted work value is read from a table based on an engine speed and first metric. A value is transmitted to a control system when the calculated work is not the predicted work value. The value, when implemented by the control system, reduces a difference between the predicted work value and the calculated work for the component.

In some variations one or more of the following features can optionally be included in any feasible combination.

The programmable processor can update at least one table comprising a parameter affecting operation of the engine. The updating can occur when the calculated work is not the predicted work value. Also, the transmitted value can be based on the parameter. The updating further can also include generating the predicted work value based on execution of a model. The model can including, as inputs, physical parameters at least partially defining the operation of the engine. The physical parameters can be updated to reduce a difference between the work and a recalculated work value based on the updated physical parameters. The updated work value can be stored to the table.

A correction can be applied to measured engine speed data based on engine inertia data to generate second engine speed data. Here, the range can be between a compression start and an expansion end and the work can be calculated over this range. The work can be stored in an expansion table when the work is greater than the predicted work. An instruction can be transmitted to a second control system to modify a delivered fuel ratio based on a fuel multiplier when a maximum work based on the second engine speed data is less than the predicted work value.

The transmitting can also include receiving a combustion phasing metric corresponding to an advanced condition or a retarded condition of a piston. Here, the fuel multiplier can be increased when the combustion phasing metric corresponds to an retarded condition and decreased when the combustion phasing metric corresponds to the advanced condition.

Also, the predicted work can be read from a compression table, where the predicted work can be based on the second engine speed data and at least one other metric. An instruction can be transmitted to a second control system to increase a delivered fuel ratio when the work is greater than the predicted work. Also, a second instruction can be transmitted to a second control system to decrease the delivered fuel ratio when the work is less than the predicted work.

When at least a portion of the engine speed data corresponds to a steady-state engine speed, a correction can be applied to measured engine speed data based on engine inertia data to generate second engine speed data. Here, the range can be between a compression start and an expansion end. Also, the work can be calculated over this range. The work can be added as an entry to a variation table. A coefficient of variation can be calculated based on the entries in the variation table.

The variation table can be cleared after transmission of the instruction. The transmitting can occur when a number of entries of the variation table is at least a predefined number.

An instruction can be transmitted to a third control system based on a comparison of the coefficient of variation to an allowable range. The instruction can be a first instruction which, when implemented by the third control system reduces the coefficient of variation when the coefficient of variation is larger than the allowable range. Or, the instruction can be a second instruction which, when implemented by the third control system, increases the coefficient of variation when the coefficient of variation is smaller than the allowable range. The first instruction can include at least one of: reducing a spark advance, reducing exhaust gas recirculation, increasing a fuel input, and reducing a throttle. The second instruction can include at least one of: increasing the spark advance, increasing the exhaust gas recirculation, reducing the fuel input, and increasing a throttle.

The engine speed data can include a number of rotations per unit time of a crankshaft. The engine speed data can be acquired over a 2-stroke or a 4-stroke combustion cycle.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram of engine speed data illustrating a combustion cycle, consistent with implementations of the current subject matter;

FIG. 2 is a diagram illustrating application of a correction to measured engine speed data, consistent with implementations of the current subject matter;

FIG. 3 is a diagram of a change in engine speed or Revolutions Per Minute (RPM) during an expansion stroke, consistent with implementations of the current subject matter;

FIG. 4 is a diagram of a change in RPM during a compression stroke, consistent with implementations of the current subject matter;

FIG. 5 is a process flow diagram illustrating modification of a delivered fuel ratio based on the change in RPM during the expansion stroke, consistent with implementations of the current subject matter;

FIG. 6 is a process flow diagram illustrating modification of a delivered fuel ratio based on the change in RPM during the compression stroke, consistent with implementations of the current subject matter;

FIG. 7 is a process flow diagram illustrating modification of a coefficient of variability based on the change in RPM during the expansion stroke, consistent with implementations of the current subject matter;

FIG. 8 is a system diagram, consistent with implementations of the current subject matter; and

FIG. 9 is a process flow diagram illustrating a method consistent with implementations of the current subject matter.

When practical, similar reference numbers denote similar structures, features, or elements.

### DETAILED DESCRIPTION

### Introduction

Variations in construction of internal combustion engines can result from mechanical or assembly tolerances, sensor accuracy, fuel quality, environmental, or electrical hardware. This can result in an engine performing at a lower efficiency, or higher emissions, than if tuned for each specific configuration. These variations in engine build can result in compromised “base” calibration parameters (control outputs based on a series of inputs) that negatively impact performance. Moreover, calibration variations can result in each engine performing differently, and in some regards worse, than the intended performance. Specifically, the combustion event can be less than optimal for many reasons including (but not limited to) one or more of a different amount of air entering the cylinder than expected (e.g. due to one or more of casting variations, camshaft manufacturing variation, throttle system deviations, or airflow sensor variability in, for example, temperature and manifold absolute pressure (TMAP) sensors, throttle position sensor (TPS), mass air flow (MAF) sensors, and throttle control deviations (cable pulley shape variability, e-throttle command deviations), and the like. Other variations can arise from a different amount of fuel entering the cylinder than expected (for example due to injector variations, fuel pressure or property (viscosity, density) variations), the fuel burning faster or slower than expected (for example due to volatility or combustion behavior of fuel variation, ignition system energy deviations, spark plug(s) gap(s) variations, compression ratio variation, in-cylinder or port wall temperature variations, ambient condition variations).

In all of these situations, the performance desired from the optimum combustion phasing as calibrated may be reduced. It is desirable to maintain optimum performance regardless of the above-noted sources of potential variability.

Electronic fuel injection (EFI) internal combustion engine systems can use a lambda sensor (an oxygen sensing device typically located in the exhaust system) to deliver feedback on air-fuel ratio of the engine. Here, lambda represents the ratio of the actual air-fuel ratio to the stoichiometric air-fuel ratio such that lambda is 1 at a stoichiometric air/fuel ratio. The reported feedback can be used to correct the delivered quantity of fuel. Narrow band lambda sensors detect air-fuel ratio in a binary sense, e.g., rich, or lean and are generally not expensive in production. Wide band lambda sensors (and appropriate ECU hardware) have the capacity to detect air-fuel ratio outside of a narrow range, but can be prohibitively expensive in low cost applications or markets. In a lean burn engine (e.g. an engine configured to operate with excess air corresponding to a lambda greater than 1), a narrow band sensor will not work. Hence, when targeting a low cost market, using wide band feedback to enable fuel or spark trims is not ideal due to the prohibitive cost of a wide band sensor. Additionally, in low cost markets, eliminating sensors in general is highly desirable. An open loop system uses sensors and models to predict the amount of air without lambda sensor feedback, and these EFI systems can be very challenging to operate robustly over aforementioned variability without a lambda sensor, even with the addition of additional sensors such as manifold air pressure sensor.

Implementations of the current subject matter can include coupling of engine speed data to a desired engine performance. This can be done by an engine control unit (ECU), which can compute a ratio of injected fuel energy to useful work in a lean burn engine without relying on lambda-sensors. Additionally, comparing parameters of speed fluctuation against previous cycles can provide a measured torque variation and related to a combustion stability metric. Such an approach can be used for adjusting control inputs or maximizing dilution (fresh air or exhaust gas recirculation (EGR)). Use of compression stroke deceleration as an indication of (e.g. a surrogate for) trapped mass can give the ECU the ability to anticipate if the engine has more or less trapped mass than expected and can provide directional guidance in trims. In addition, averaging this value over sufficient engine cycles can enable use of a learned table for the engine's primary load (e.g., airflow) quantification from which fuel, spark, and other quantities are determined. And finally, using the phasing of engine speed transitions relative to crank angle from low to high speed (or some other metric related to the crank angle at which an RPM increase occurs) can be used to indicate combustion phasing (e.g., advanced or retarded combustion) and appropriate compensations can be applied.

Measurement of, for example, instantaneous RPM of a crankshaft at multiple locations with respect to the combustion cycle (720 degrees or two revolutions if 4-stroke or 360 degrees if 2-stroke), can provide engine speed data to the ECU corresponding to a compression/combustion/expansion cycle of each cylinder. Because these are real measurements, a correction can be applied to convert the engine speed data to idealized engine speed data. Then, as described in further detail below, the idealized engine speed data during the expansion phase or compression phase can be used to alter engine operation to optimize performance. A similar method can be implemented to reduce the variation in engine operation. Doing so can allow operation closer to a combustion stability threshold, which in turn can increase engine performance.

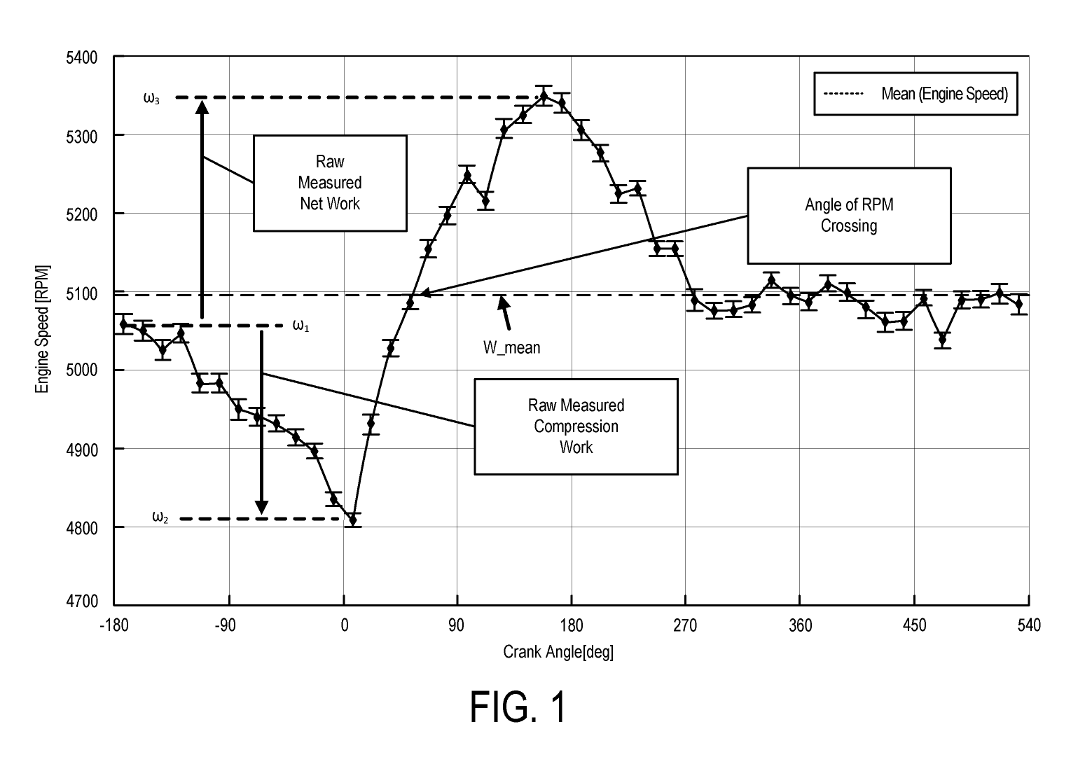

The example plot of engine speed data shown in FIG. 1 shows how the RPM of an engine, typically measured at the crankshaft, varies over a combustion cycle. Taken over a sufficiently long time scale, the engine can have an average RPM, shown here to be about 5100 RPM. When the instantaneous engine speed is plotted in terms of the crank angle (the angle of rotation of the crankshaft), it can be seen that the engine speed decreases during the compression phase and increases rapidly after a combustion event. The combustion event occurs at crank angle of approximately zero. After the expansion phase, the engine speed returns to around the average engine speed until another combustion cycle occurs.

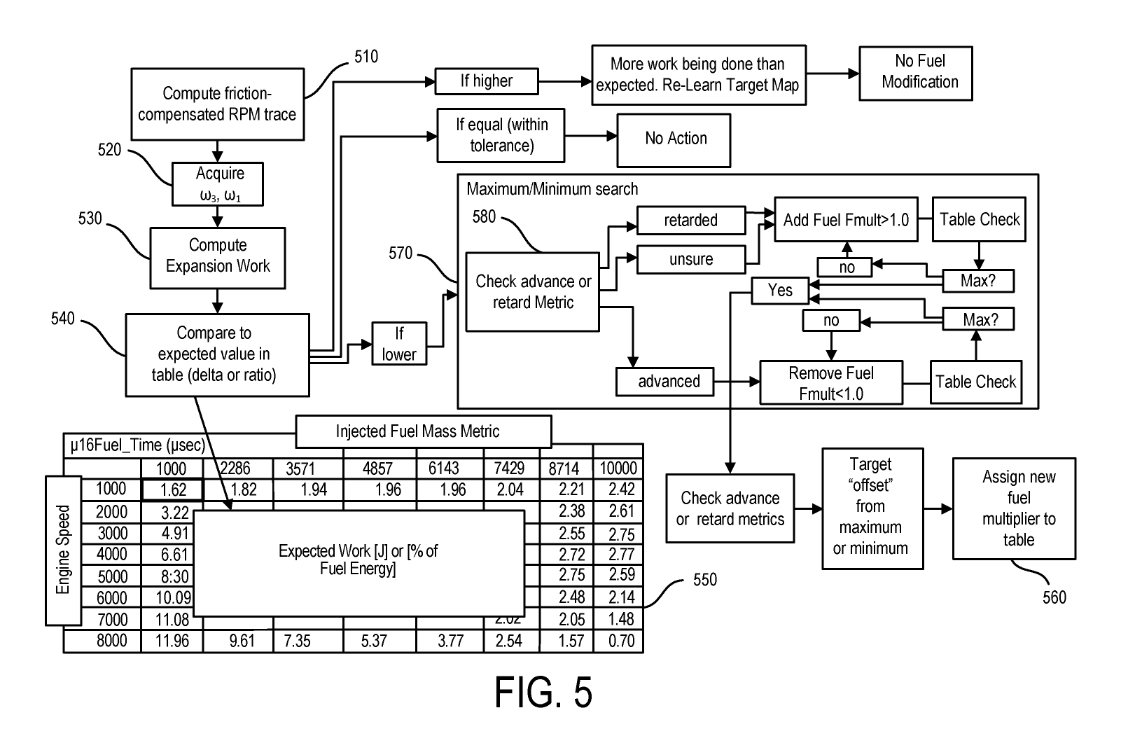

There are three particularly interesting data points shown in FIG. 1. The first is ω₁, which is the instantaneous engine speed (or angular speed of the crankshaft, i.e. in rotations/min) present at the start of the compression phase. The second is ω₂, which is the engine speed at the end of the compression phase (or equivalently at the combustion event/start of the expansion phase). The third is ω₃, which is the maximum engine speed during the expansion phase. Also indicated is the angle of angle of nominal-RPM crossing, which is the crank angle at which the engine speed, which has slowed during compression, crosses the median (ω_mean) speed in the expansion phase. This crank angle of RPM crossing can be important for combustion phasing optimization and is discussed in further detail with regard to FIG. 5.

Measuring a change in engine speed can allow a calculation of the work done to angularly accelerate a corresponding inertia corresponding to rotating components of the engine based on a change in the engine speed data over a specific crank angle window. For example, the change in engine speed in the range of ω₁ to ω₃ can be representative of the useful work in the combustion cycle. Similarly, the change in speed from ω₁ to ω₂ can be representative of the work done on the air-fuel mixture in a combustion chamber of the engine during compression. Here, combustion chamber indicates the volume defined at least in part by the cylinder, one or more piston crowns, and, optionally, a cylinder head.

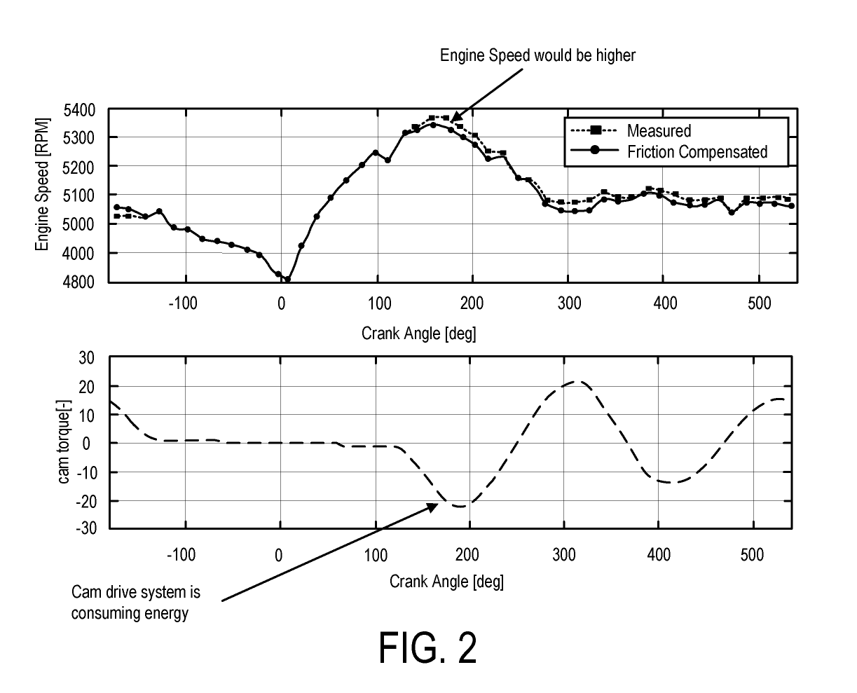

FIG. 2 is a chart illustrating application of a correction to measured engine speed data to known angle-resolved work (e.g., valvetrain or cam drive torque), consistent with implementations of the current subject matter. This compensation can be used to get a more accurate model of the work done by the combustion event. In an average sense, the useful energy provided during a combustion cycle can be expressed as:

FE=PW×FR×FED, (1)

where FE is the delivered fuel energy on any specific cycle (J), PW is an injector pulse width (s) during which fuel is delivered to the combustion chamber, FR is an injector flow rate gain (Us) that describes the rate at which a unit volume of fuel is introduced into the cylinder, and the FED is the fuel energy density, here expressed in M. This represents an idealized useable amount of energy.

The energy required to change the rotational speed of the crankshaft, for example from ω₁ to ω₂, is given by:

W=1/2I(ω₂²−ω₁²). (2)

Here, W refers to “inertial work,” again the energy used to change the rotational speed of a crankshaft having inertia I to ω₂ from ω₁. I can represent the engine inertia, which can include the inertia of the crankshaft and all other rotating components that inertially resist changes to the rotation of the crankshaft. In other words, I can be the “effective” inertia of the crankshaft or engine.

The engine inertia can include contributions of any rotating components directly connected to the crankshaft. The inertial contribution of such components (e.g., crank, flywheel, clutch, camshaft, cam drive system, oil pump, water pump, etc.) can be weighted by their respective gear ratios. The engine inertia can also include, for example, gearbox, drive shaft, and even vehicle inertias. In the case of a discrete or continuously variable transmission, a lookup table or wheel speed sensor can be used to determine the active gear ratio. The active gear ratio can be used to apply an effective inertia of each rotating component at its respective rotating ratio. This can result in a more accurate value of the engine inertia used by the ECU when calculating the work done during expansion and compression. Moreover, a simplified or even complete torsional dynamic model can be implemented internal to the ECU software to separate the acceleration work induced by gas pressure (e.g. resulting from a combustion event) and load inputs due to other drive systems or parasitic losses. This can enable removal of various system oscillations, which can be a function of system stiffnesses and damping. Engine speed data can also include a preloaded lookup table of solved engine speed data profiles for the system at its existing configuration.

However, as this is a real system there are losses which result in the measured engine speed shown in FIG. 1 and the top panel of FIG. 2. The losses are primarily due to friction and can be expressed as:

FW=Tq*Δθ (3)

FW is the frictional work, or work “lost” by the engine due to frictional energy loss. Here, Tq is the energy dissipated by friction per unit angle and Δθ is the change in crankshaft angle, which is about 180 degrees between ω₁ and ω₂. There can be a computational model for the crankshaft torque independently applied to the crankshaft. “Independently applied,” as used herein refers to the torque resulting from forces other than the expansion of the fuel mix during combustion. FW can vary with crankshaft angle and is shown (in terms of torque) by the bottom pane in FIG. 2. The measured engine speed data can be “corrected” to eliminate this loss to provide an idealized estimate of what the engine speed should be based only on the burning of the fuel and not on the particularities of the mechanical system. This friction compensated data is shown in the top panel of FIG. 2.

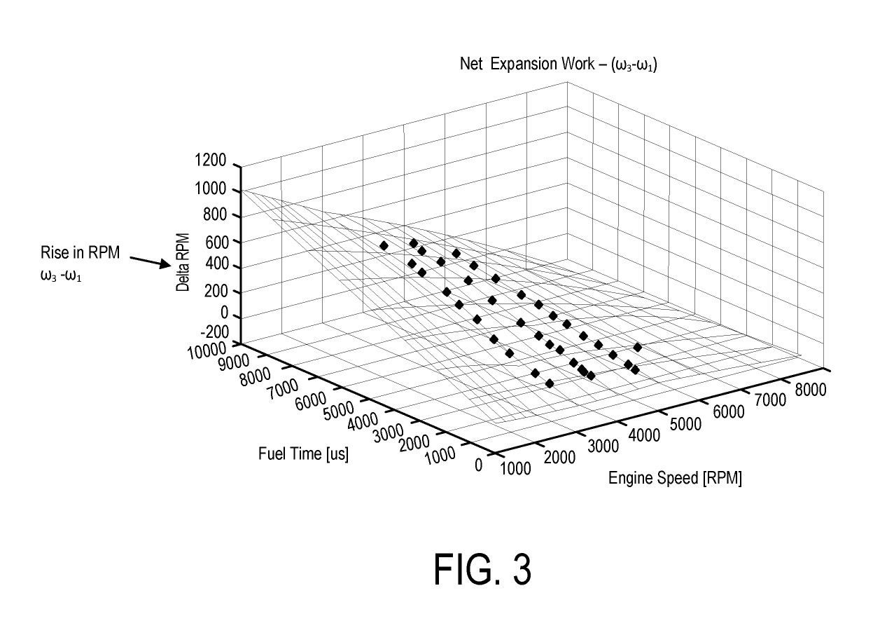

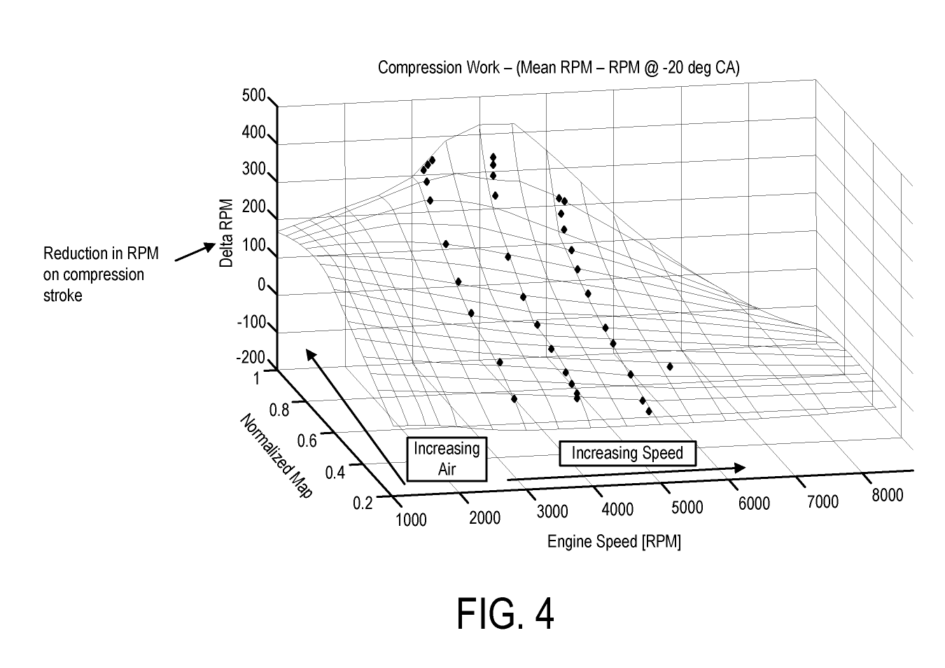

FIG. 3 is a chart showing a change in RPM during an expansion stroke, consistent with implementations of the current subject matter. FIG. 4 is a chart showing a change in RPM during a compression stroke, consistent with implementations of the current subject matter.

During engine operation, engine speed data can be acquired in an ongoing manner to store, in a computer memory, a collection of engine speed data across a number of engine operating points. In some implementations, the engine speed data can be stored in a tabular format. As shown in FIG. 3, engine speed data points are plotted at sampled values of engine speed (RPM) and fuel time (μs). Here, fuel time can refer (equivalently) to the fuel mass delivered to the cylinder. At each data point, for a given engine speed and fuel time, a change in the crankshaft speed can be measured. The measured change can also be corrected to account for the inertial model as described above. The surface plot can represent an interpolated and/or extrapolated surface corresponding to the engine speed data (which can be corrected engine speed data or uncorrected engine speed data). A surface that is generally smooth can indicate that there are sufficiently few abnormalities in the system. An engine speed data point off the surface can indicate an anomalous event or an error in the assumed inertial model.

Similarly, the chart of FIG. 4 illustrates the change in engine speed from ω₁ to ω₂ as a function of nominal (average) engine speed and fuel time (e.g., fuel mass) delivered into the combustion chamber. The smoothness of the surface indicates the amount of intra-cycle engine speed trends very smoothly with the delivered fuel mass and engine speed.

### Optimizing Fuel During Expansion Stroke

FIG. 5 is a process flow diagram illustrating features that can be included in a method for modification of a delivered fuel based on the change in RPM during the expansion stroke, consistent with implementations of the current subject matter.

As shown in FIG. 5, by 510-530, at each engine cycle, the ECU can compute the amount of fuel energy added to the system on the previous fuel pulse event. The computed amount of fuel energy can be converted to a mass of fuel based on a lookup table 540 that can relate volume to pulse duration and fuel density. The energy (in Joules or BTUs) of fuel injected for that cycle can be computed via an assumed fuel energy density, for example, a Lower Heating Value (LHV). The LHV and fuel energy density are also parameters that can be learned by storing calculated values in a computer memory over time.

Implementations of the current subject matter, for example at 540, can include defining a work ratio of injected fuel energy divided by the energy required to increase an engine's inertia intra-cycle as a metric to modify an engine control parameter. This work ratio can be stored in a table 550 and can be, for example, a function of injected fuel energy and nominal engine speed. The table 550 can represent the target ratio (as mapped or learned) for a given mass of fuel injection and speed. The data in the table 550 can provide an indication of the brake efficiency performance of the engine. The ECU can read an expected work value or ratio from the table 550 based on an engine speed and some other metric, for example the injected fuel mass. This can enable real-time, or nearly so, compensation for a multitude of variables not controllable in manufacture, environment, or operation. Higher work ratios can indicate that more acceleration has been extracted from a given energy of fuel input, reflecting engine operation at a higher efficiency.

The ECU can utilize a model that modifies the measured speed profile (e.g., acceleration or deceleration) to a predicted speed profile by adjusting or removing the influence of cycle-resolved parasitic losses and energy storage/return systems (e.g., valvetrain springs, piston inertial torque, electrical charge current, piston ring friction, induction/exhaust pumping work, etc.). The predicted work value can be generated based on execution of the model that can include, as inputs, the physical parameters at least partially defining the operation of the engine. The physical parameters can include, for example, energy losses and changes to the inertia of the components that make up the engine.

In some implementations, rather than treating the engine inertia as static, the engine's physical parameters can be updated my matching the measured work done by one or more combustion events to the recalculated work value based on the updated physical parameters. For example, the engine's effective inertia can be a learned parameter. The updating can be performed using an iterative method or any other minimization and/or search algorithm. When the optimum match between the work and a recalculated work is found, physical parameters of the engine can be stored for future use in comparison against table 550.

As described previously, a correction to measured engine speed data based on known angle-resolved torque profiles can be applied, at 510, to the engine speed data to generate a second crank-angle-resolved engine speed data. In the case shown in FIG. 5, at 520, the range over which the work is calculated is between a compression start (ω₁) and an expansion end (ω₃).

In this manner, the ECU has the capability to determine whether the fuel that was injected was utilized to an optimized (e.g. ideal) level. Deviations from this the predicted work value can be an indication that a tolerance or deviation from intended operating conditions has resulted in a lower (or higher) efficiency than expected. The target value can be a stored as a lookup map.

The phasing (crank angle) at which a rapid acceleration event occurs can also be indicative of whether the system has a combustion event advanced (before optimum) or retarded (late from optimum) timing. Lookup tables of metrics utilizing the angle of peak acceleration (or other metrics around the rising edge of the acceleration curve such the maximum positive rate-of-change-of-RPM) will enable directional control authority.

At 560, in response to the predicted work value (from the table) and the calculated work (based on the engine speed data) being different, the amount of fuel provided to the engine can be adjusted by calculating and applying a fuel multiplier used to specify the amount of fuel.

If the calculated work is equal to, within a specified tolerance, the predicted work value, then the table 550 can remain unchanged. If the calculated work is higher than the predicted work value (outside of the specified tolerance), the table 550 can be updated to store the calculated work at, for example, the given engine speed and injected fuel mass.

If the calculated work is less than the predicted work (again, outside the specified tolerance), then the ECU can execute an optimization sweep (or Maximum/Minimum Search) of fuel ratios to find a fuel multiplier that reduces the difference between the predicted work value and the calculated work. An example implementation of this approach is described below.

### Maximum/Minimum Search

Referring again to FIG. 5, at 570 when the calculated work is less than the predicted work value, fuel flow can be increased or decreased, depending on whether the motion due to the combustion phasing is retarded (firing late) or advanced (firing early). At 580, the ECU can receive a combustion phasing metric corresponding to an advanced condition or a retarded condition of a combustion event, e.g., angle at which highest climb in engine speed occurs. The combustion phasing metric can characterize the timing of the combustion event and be received from either the crankshaft speed signal or an additional sensor connected to the engine that detects the timing of the combustion event relative to the crank angle of lowest volume (e.g., TDC).

The fuel flow modification can be expressed in terms of a fuel multiplier that modifies the value determined by the ECU for the engine's existing operating condition. When the combustion phasing, represented by the combustion phasing metric, indicates an advanced combustion event (e.g., fuel ignition occurs earlier than desired), the fuel multiplier can be decreased (this will retard combustion phasing). Similarly, when the combustion phasing metric corresponds to a retarded combustion event (e.g. fuel ignition occurs later than desired) condition the fuel multiplier can be increased. If the combustion phasing metric does not provide a definite indication of whether ignition during the cycle is advanced or retarded, a default decision can be implemented by the ECU. For example, as shown in FIG. 5, the default decision can be to increase the fuel multiplier as if ignition during the cycle was retarded. In other implementations, the default condition can be to decrease the fuel multiplier as if ignition during the cycle was advanced.

For example, if an ignition occurs later than expected (a retarded condition determined from a mapped and/or learned table), the combustion phasing is likely late, so the optimization sweep of fuel multiplier is expected to result in a fuel multiplier greater than 1.0. If correct, once the optimization sweep begins and fuel is added, the difference between the measured work compared to what is expected from the 550 table lookup should decrease. This indicates that the ECU is compensating in the right direction and should continue to do so until the predicted work value is achieved or an optimum condition (max brake efficiency, minimum difference to predicted work value) is found. If the computed difference to the predicted work value increases (e.g., the table value minus the delivered value increases), the engine is performance is deteriorating and the ECU can reverse fuel modification to the other direction (in this case, removing fuel) until a local maximum is found. The new local maximum can be stored as the new predicted fuel ratio, and the fuel multiplier associated with that maximum can be stored.

Once the new fuel multiplier is determined, the ECU can transmit a value representing the fuel multiplier to a control system. The new fuel multiplier, when implemented by the control system, can reduce a difference between the predicted work value (from the table) and the calculated work (based on the engine speed data) for the component by modifying a delivered fuel ratio based on the new fuel multiplier.

As a control goal, a simple maximum may not be the desired target due to the coupling with emissions (specifically NO_{X}). Criteria can be provided to enable the system to target an offset from a maximum to maintain the “right” combustion phasing. The targeted offset can be a fuel ratio or fuel multiplier away from the local maximum. In another implementation, the targeted offset can be a spark trim added during the maximization sweep. The spark trim can be subsequently removed to ensure that a fixed angle offset from maximum work ratio is achieved.

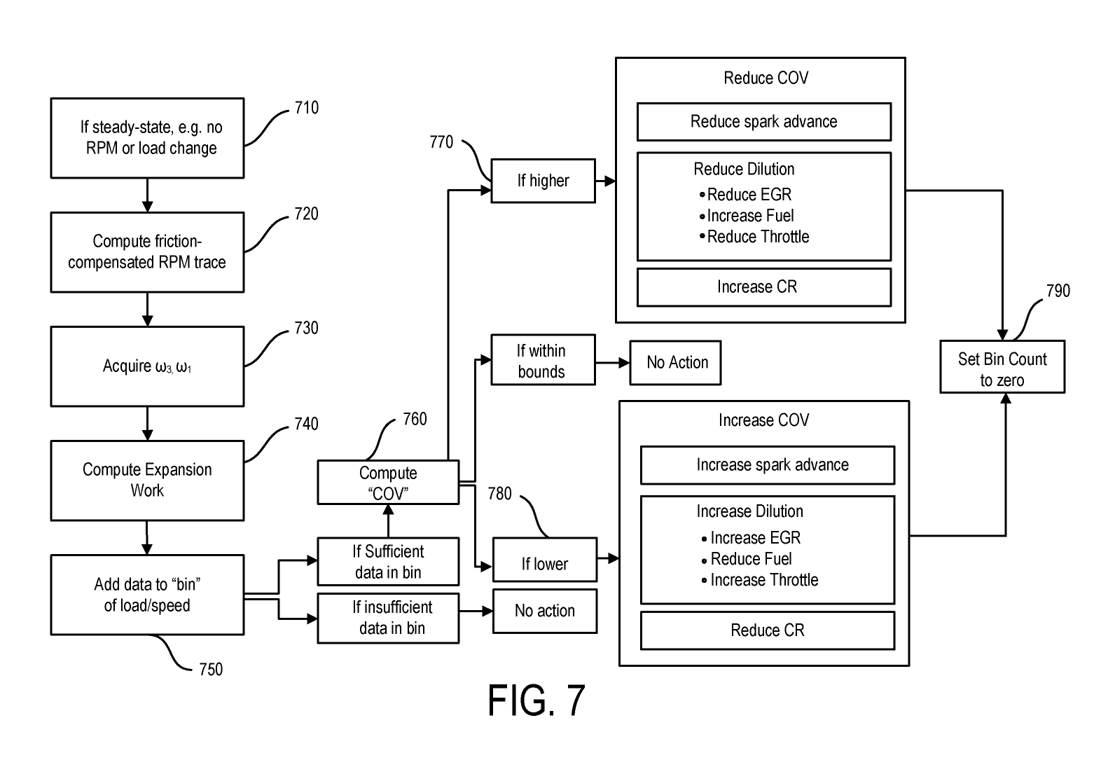

Approaches described herein can also be effective under throttled stoichiometric operation, although fuel trim may be dictated via oxygen (lambda) sensor feedback in the exhaust for proper catalyst function. In throttled stoichiometric operation, if a deviation from delivered work to expected work is observed, an additional trim that is not fuel related can be required to enable the engine to remain near-stoichiometric. The additional trim can include one or more of compression ratio, spark advance, variable valve timing (internal EGR), coil energy (dwell), compression ratio (if variable), or any control variable available to advance/retard combustion. In stoichiometric engines with EGR, the EGR level may be swept similarly for maximum efficiency (see also the discussion of FIG. 7). Any variable available to the ECU may be swept to maximize this fuel ratio (e.g., exhaust restrictions, injection strategies, etc.).

In some implementations, the ECU can transmit, to a control system, instructions having a value which, when implemented by the control system, is expected to result in a change to the calculated work for an engine component. The change can expected to result from the change which can be part of an investigative trial for seeking an improvement of the calculated work to exceed the predicted work value. Based on the change of operation, a corresponding change in engine speed can be measured. The measured change in engine speed can then be compared to, for example, the engine speed before the change in operation to determine if the instruction was beneficial. As a consequence, the work calculated between points in the combustion cycle can change. If beneficial, the ECU can store the instruction or operating point of the component and implement it to improve the operation of the engine. If not beneficial, the engine can be controlled to return to the previous operating state. The expected values stored in the table can be updated either in response to a measured improvement in operation (as described above) or in response to an optional sweep of operating parameters. The sweep of operating parameters can include controlling engine components to change the engine speed and another metric, for example, injected fuel mass or airflow, to map out an operating surface under the current engine configuration. The new map can be stored as a table or used to overwrite an existing table, for example, the expansion table 550 or compression table (described below).

In multi-cylinder engines, the engine speed data associated with each individual cylinder's expansion stroke can be used to compensate each individual cylinder's operating conditions. In some implementations, the engine speed data analysis described above can indicate a failure mode of one of the cylinders (e.g., spark plug fouled on cylinder #2, etc.). The ECU can generate an error code based on the failure mode that can be transmitted to another control system or diagnostic computer. The diagnosed error can be displayed, logged, or taken into account in subsequent operation of one or more control systems in the vehicle.

### Optimizing Fuel During Compression Stroke

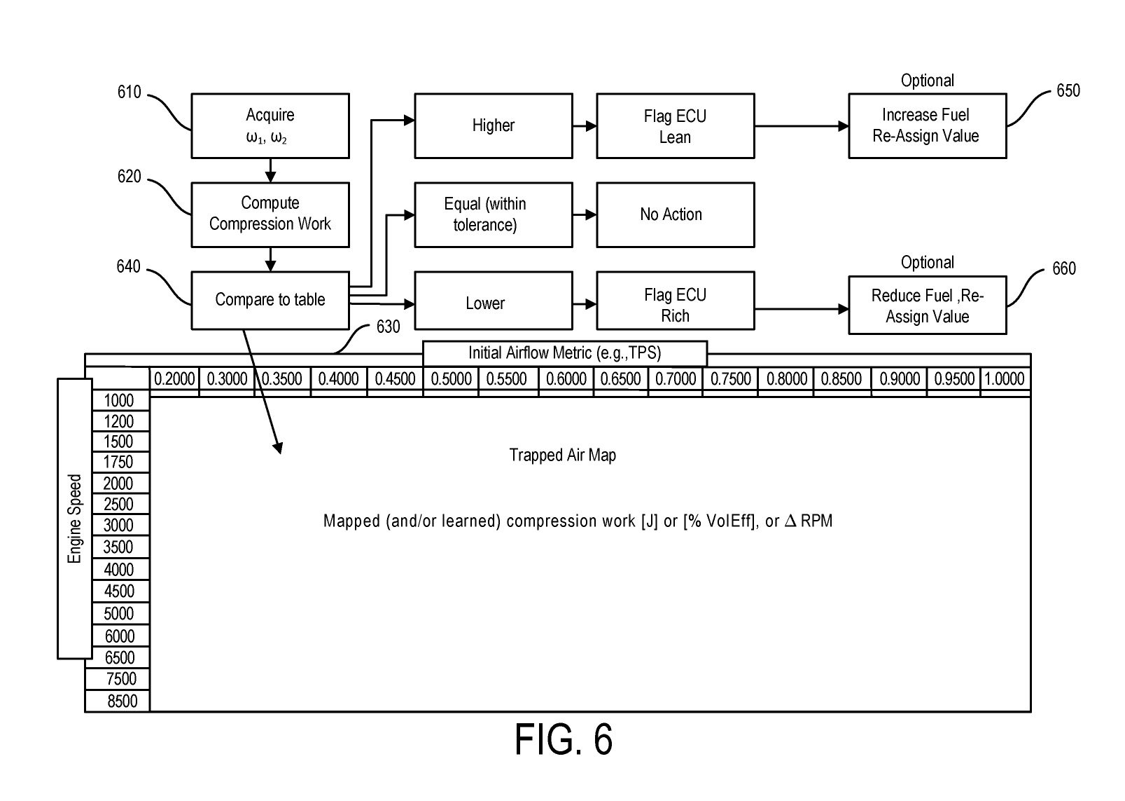

FIG. 6 is a process flow diagram illustrating how the crankshaft speed profile may be used to predict the amount of charge mass in the cylinder due to compression stroke speed reduction. This information may be used as an indicator of direction to modify the delivered fuel ratio, consistent with implementations of the current subject matter. The amount of compression work (during the compression stroke) can be highly correlated to the amount of trapped air mass. As used herein, trapped air mass refers to the mass of fresh air injected to the cylinder on any given cycle, regardless of the air-fuel ratio. More trapped air mass (from less throttling) results in higher compression work and so more engine speed slowdown on the compression stroke. The trapped air mass can be normalized by assumed (or calculated) compression ratio and known ambient conditions to convert to a true trapped mass map. The trapped air mass can be used either as a primary airflow metric or as a check against the ECU's expected airflow model. For example, if the measured engine speed reduction is higher than expected, the ECU can determine that there is more trapped air than expected and compensate fuel (or another parameter) accordingly. The normalized trapped air mass can be physically converted to a mass of air, or volumetric efficiency, by assuming a compression ratio, isentropic assumptions or a simple heat loss and blowby/crevice model, and utilizing any ambient conditions (e.g., air temperature, pressure) known to the ECU.

As shown in FIG. 6, at 610-620, and similar to that described for the expansion stroke, the ECU can first apply a correction to measured engine speed data based on engine inertia data to generate second engine speed data. The second engine speed data, similar to that described in FIG. 5, can be used by the ECU to calculate the work during the compression phase. In this case, the range over which the work is calculated is between a compression start (ω₁) and a compression end (ω₂).

The predicted work can be read from a compression table 630, where the predicted work can be based on the second engine speed data and at least one other metric. In the example shown in FIG. 6, the metric is the initial airflow metric. The initial airflow metric can be measured by any type of sensor(s), for example a TPS, and provided to the ECU.

The work during the compression phase can be correlated with a trapped air mass in the piston. As a secondary comparison, the trapped air mass can be compared to a trapped air mass table that includes values of predicted (or expected) trapped air masses. This is reflected in FIG. 6, which shows a normalized quantity (either trapped air mass or predicted work). The measured change in engine speed can be mapped, based on the correlation described above, to a change in trapped air mass during the compression phase. Based either on a determined difference between the calculated trapped air mass and the predicted trapped air mass, or between the measured work and the predicted work, the operation of the engine can be altered. The example below is based primarily on comparing the measured work to a predicted work, similar to that described for the expansion phase.

Based on a comparison, at 640, between the measured work and the predicted work, the delivered fuel or spark advance can be modified. In some implementations, at 650, an instruction can be transmitted to a second control system to increase a delivered fuel ratio when the work is greater than the predicted work. Similarly, in some implementations, at 660, a second instruction can be transmitted to a second control system, to decrease a delivered fuel ratio when the work is less than the predicted work.

Additionally, the knowledge of the amount of trapped air mass is available to the ECU at the crank angle of the value selected for ω₂. Because fuel may have already been delivered on that cycle (e.g., port fuel injected with the inlet valve already closed), this term may offer a compensation for spark to best extract performance from that cycle. The compensation can be based on any miss or a difference with the air handling system prediction (e.g. TPS or manifold air pressure based airflow model).

In other implementations, the measured work can be written to the compression table 630 and used for later comparisons. In particular, the compression work can be used to “learn” the airflow profile of the engine for a given throttle assembly and eliminate required sensors (for example, a manifold pressure sensor). Enabling pure throttle-RPM (“speed-alpha”) EFI control without a lambda sensor for fuel feedback can be extremely challenging in practice because throttle blade deposit buildup, idle air bleed screw, throttle position sensor (TPS) sensor alignment, and/or variable machining tolerances for blade-to-bore clearance can result in large differences of airflow for a given TPS reading. These tolerance stackups can make it difficult to produce reliable airflow characteristics, particularly at near-closed throttle positions. As such, using the compression stroke deceleration to re-learn the airflow characteristics of the throttle assembly over time enables the ECU to adapt calibration parameters to the changing airflow.

Transient characteristics can also be learned and characterized by updating the compression table with data during operation. For instance, during rapid throttle change, the trapped air mass is fixed during a cycle. This can allow the RPM-based trapped air mass parameter to show a clean trapped air mass vs. time. As a result, the ECU can adapt transient trims. This parameter can also be utilized to adjust dynamic trims. For example, knowing the trapped mass with an EGR system, in conjunction with the manifold air pressure and some mechanism of understanding the mass in the inlet runners, enables the ECU to understand the live trapped air mass in the cylinder during transients. Any control output parameter that controls combustion phasing (spark timing, PFI or DI fuel, compression ratio, etc.) can be adjusted to best capture transient performance with data that arrives on the compression stroke. In multi-cylinder engines, the engine speed data fluctuation associated with each individual cylinder's compression stroke can be used to adjust individual cylinder trims.

Knowing the difference between a measured trapped air mass via crank deceleration on the compression stroke compared to what the ECU had expected (as calibrated or learned) can also provide directional guidance on whether a given combustion chamber is most likely to have early or late combustion (a more dilute air-fuel mixture than expected generally results in later than expected combustion, and vice versa). This also depends on the difference in measured work during the expansion stroke compared to the predicted work. For example, if crankshaft deceleration during the compression stroke is higher than as-mapped (or learned), the engine likely has more trapped mass than calibrated, so is most likely more dilute and therefore will result in later ignition. Hence, in this case, the ECU could compensate with perhaps a controlled level of additional spark advance or another direct injection pulse to add fuel.

### Optimizing the Coefficient of Variation

FIG. 7 is a process flow diagram illustrating modification of a coefficient of variability based on the change in RPM during the expansion stroke, consistent with implementations of the current subject matter. For emissions, drive feel (run quality), or fuel economy reasons, it can be beneficial for the engine to operate at, but no greater than, a target combustion stability threshold. However, operating near the combustion stability threshold of an engine can make the system much more sensitive to small calibration errors. To ensure that engine build or operating variability does not result in exceeding this combustion stability threshold, engines are often operated in a more stable regime to allow the worst-case construction to still meet combustion stability targets. Specifically, a safety margin can be added which and typically implemented in a calibration specification that errs on the stable side of the combustion stability threshold to account for downstream system variability.

Combustion stability thresholds can include a coefficient of variation (COV) of indicated mean effective pressure (IMEP). IMEP is an indication of the work done per combustion cycle and COV is typically calculated as the standard deviation of the population divided by the mean value in units of percent. The COV of IMEP is often limited to ˜3-5% on normal driving loads. However, quantifying IMEP requires a cylinder pressure transducer which is far too expensive for mass production. The variability of the acceleration of the crankshaft (e.g., the inertial work imposed) can be used in place of IMEP to produce a similar metric without the cylinder pressure sensor.

As shown in FIG. 7, at 710-730, a correction to measured engine speed data based on engine inertia data can be applied to the engine speed data to generate second engine speed data. At 740, the second engine speed data, similar to that described in FIG. 5, can be used by the ECU to calculate the work. In this case, the range over which the work is calculated is between a compression start (ω₁) and an expansion end (ω₃). Furthermore, the process of adjusting the COV can be applied when the engine speed data corresponds to a steady-state engine speed. Steady-state can refer to relatively few accelerations or decelerations, or a sufficiently long averaging time over which the effect of engine speed changes are small compared to an average engine speed.

Once the work has been calculated, the work can be added as an entry to a “bin” or variation table (not shown). The variation table can store the work values acquired per cycle or can apply a running mean and/or a running standard deviation of the sample size. At 760, the ECU can calculate the COV by accessing the variation table or computed standard deviation or other statistical parameter that quantifies the work done per cycle (calculated with the engine speed data) to accelerate the engine's effective inertia as computed by the methods described herein.

In some implementations, the variability of engine speed increase on the expansion stroke over a number of cycles can provide the ECU with a direct measurement of this combustion work variation. Hence, the ECU can compute the COV of the stored work values, or some other variation parameter, over a predefined number of previous cycles, for example, 5, 10, 20, 100, etc. Because a sufficient statistical sample is preferred, the calculation of the COV and transmission of instructions to alter engine operation can occur only when the predefined number of cycles has been stored in the variation table or statistical confidence parameter has been computed and evaluated to meet a particular confidence threshold. The confidence threshold can be when the sample size has a standard deviation of, for example, less than 1%, 5%, 10%, etc.

The computed COV can characterize whether the engine is unstable (COV too large) or too stable (COV too small). At 770, the ECU can reduce the COV when the COV is higher than an allowable range, for example by one or more of reducing a spark advance for the engine cycle, reducing dilution and/or exhaust gas recirculation, increasing fuel, reducing throttle, and/or increasing a compression ratio. Alternatively, at 780, the ECU can increase the COV when the COV is lower than the allowable range, for example by one or more of increasing a spark advance for the engine cycle, increasing dilution and/or exhaust gas recirculation, reducing fuel, increasing throttle, and/or reducing a compression ratio.

At 790, the data from the variation table can be deleted, cleared, or otherwise reset after the ECU transmits instructions. In this way, the ongoing monitoring of the COV by the ECU can be continuously refreshed with new engine speed data that is more representative of current engine operation.

In some implementations, corrections to reduce COV of IMEP when unstable, or increase COV of IMEP when too stable, can be implemented by applying a combination of spark, fuel, or other control parameter trims. For example, if the ECU recognizes the engine is operating at 12% COV (as determined by the standard deviation of a metric generated from the crank speed or engine speed increase on the expansion stroke), the ECU could transmit instructions to reduce dilution (increase fuel, reduce EGR, or reduce throttle) and remove spark advance simultaneously. The combination of fuel/spark trims can be mapped, or stored in a table, such that the appropriate fuel can be added and spark removed to stabilize the combustion event while also maintaining the desired combustion phasing. This approach can enable operation much closer to the combustion stability limit and perhaps extend the nominal target due to reduced variation from the target.

The aforementioned COV criteria can occur in conjunction with the other system strategies and can be coupled to other goals. For example, if knock is not detected, and COV is higher than target, the compression ratio (if variable) can be increased. This can enable threshold knock combustion to be detected by the engine in real or near-real time (e.g. live) such that the ECU can adjust dilution and CR to match target COV (maximize dilution) and extract the maximum efficiency from the system regardless of system tolerances. Doing so can enable dilution and CR to become a variable dependent on knock and COV thresholds.

In multi-cylinder engines, if higher COV is recognized on one of the cylinders, it can be used to re-learn spark or dilution targets individually (if EGR is distributed individually). In other implementations, the applied change in operation can be limited to only the cylinder having the COV with the largest deviation to balance each cylinder's performance. Further, the most unstable cylinder can be operated at a slightly richer mixture while others are operated to run leaner. This can net an exhaust mixture that is still within target (near stoichiometric) mixture composition to maximize catalyst conversion efficacy.

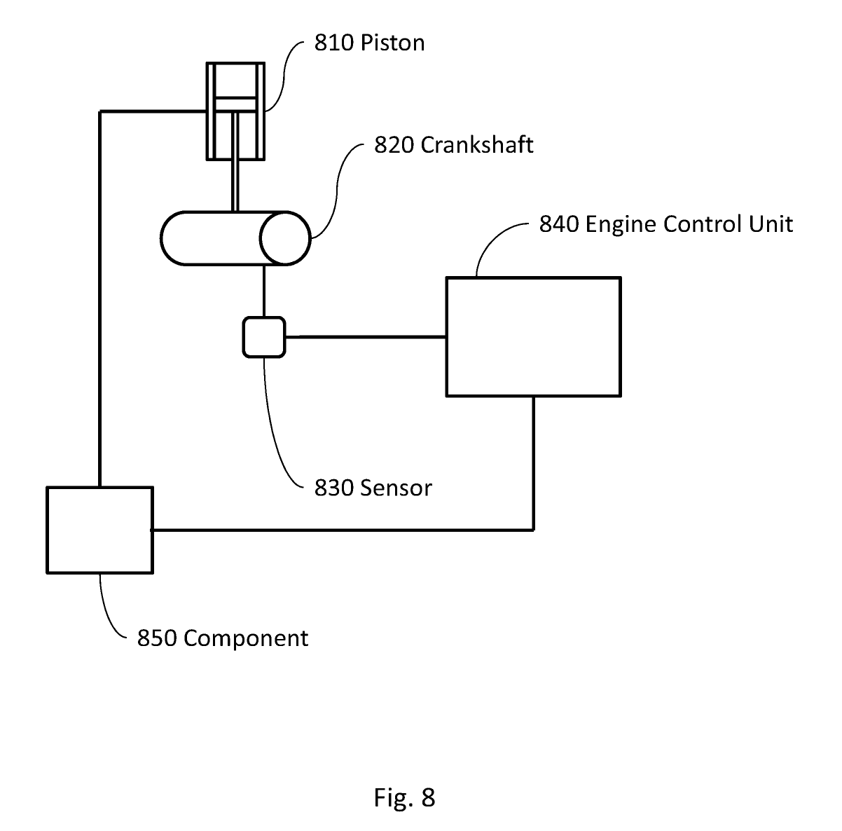

FIG. 8 is a system diagram, consistent with implementations of the current subject matter. A piston 810 can be operatively connected to a crankshaft 820. Engine speed data can be measured by a sensor 830 operatively connected to the crankshaft 820. The engine speed data can be received by the ECU 840. The ECU 840, as described herein, can transmit instructions to one or more components 850 of an engine. The components 850 can be operatively connected to or can include, for example, ignition system components such as spark plugs, throttle controls, valve timing and/or lift control components, etc.

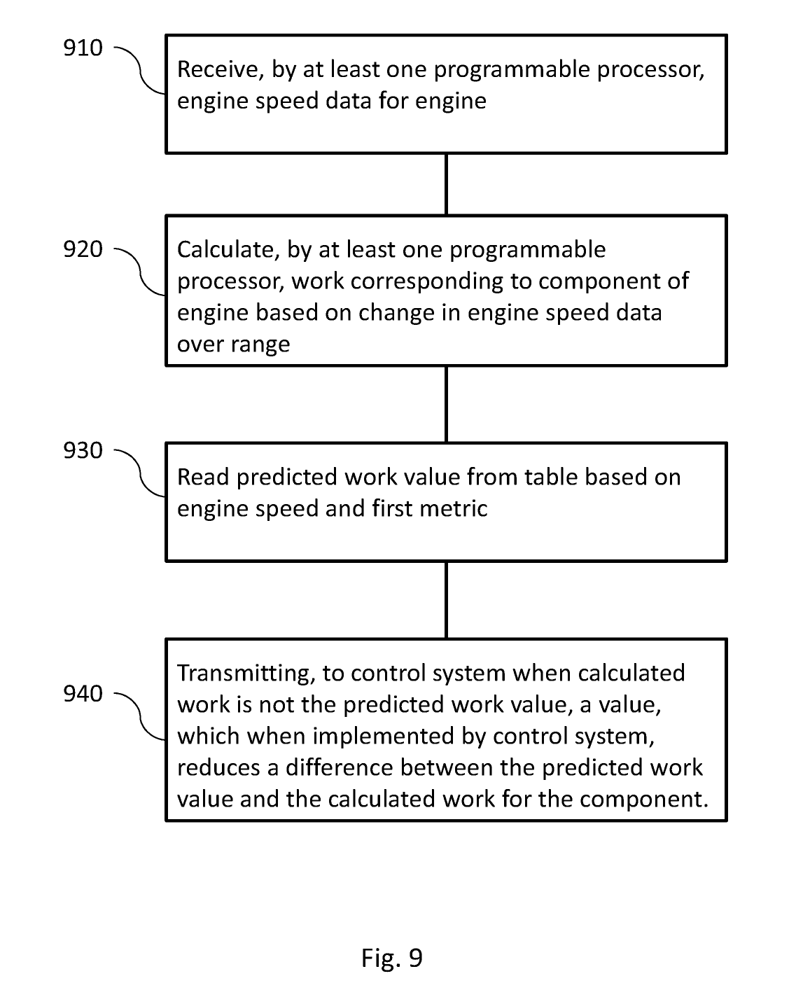

FIG. 9 is a process flow diagram illustrating features of a method consistent with implementations of the current subject matter. At 910, engine speed data for the engine can be received by the ECU 840. At 920, the ECU 840 can calculate the work corresponding to the component of the engine, for example the crankshaft 820. The calculation can be based on a change in engine speed data over a range. At 930, the ECU 840 can read a predicted work from a table or calibration function based on the engine speed and a first metric. At 940, a value can be transmitted to a control system when the calculated work is not the predicted work value. The value, when implemented by the control system, reduces a difference between the predicted work value and the calculated work for the component.

The details of one or more variations of the subject matter described herein are set forth in the accompanying drawings and the description below. Other features and advantages of the subject matter described herein will be apparent from the description and drawings, and from the claims.

Implementations of the current subject matter can include, but are not limited to, methods consistent with the descriptions provided above as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claim.

1. A computer program product comprising a non-transient, machine-readable medium storing instructions which, when executed by at least one programmable processor, cause the at least one programmable processor to perform operations comprising:
receiving, by the at least one programmable processor, engine speed data for an engine;
calculating, by the at least one programmable processor, a work corresponding to a component of the engine based on a change in the engine speed data over a range;
reading a predicted work value from a table based on an engine speed and first metric; and
transmitting, to a control system when the calculated work is not the predicted work value, a value which, when implemented by the control system, reduces a difference between the predicted work value and the calculated work for the component.

2. The computer program product of claim 1, further comprising:
updating, by the at least one programmable processor when the calculated work is not the predicted work value, at least one table comprising a parameter affecting operation of the engine, wherein the transmitted value is based on the parameter.

3. The computer program product of claim 2, the updating further comprising:
generating the predicted work value based on execution of a model including, as inputs, a plurality of physical parameters at least partially defining the operation of the engine;
updating at least one of the plurality of physical parameters to reduce a difference between the work and a recalculated work value based on the updated physical parameters; and
storing the updated work value to the table.

4. The computer program product of claim 1, wherein the engine speed data comprises a number of rotations per unit time of a crankshaft.

5. The computer program product of claim 2, further comprising:
first applying a correction to measured engine speed data based on engine inertia data to generate second engine speed data, wherein the range is between a compression start and an expansion end and wherein the work is calculated over the range;
storing the work in an expansion table when the work is greater than the predicted work; and
transmitting, to a second control system, an instruction to modify a delivered fuel ratio based on a fuel multiplier when a maximum work based on the second engine speed data is less than the predicted work value.

6. The computer program product of claim 5, the transmitting further comprising:
receiving a combustion phasing metric corresponding to an advanced condition or a retarded condition of a piston;
increasing the fuel multiplier when the combustion phasing metric corresponds to a retarded condition; and
decreasing the fuel multiplier when the combustion phasing metric corresponds to the advanced condition.

7. The computer program product of claim 2, further comprising:
first applying a correction to measured engine speed data based on engine inertia data to generate second engine speed data, wherein the range is between a compression start and an expansion end and wherein the work is calculated over the range;
reading, from a compression table, the predicted work based on the second engine speed data and at least one other metric;
transmitting, to a second control system, an instruction to increase a delivered fuel ratio when the work is greater than the predicted work; and
transmitting, to the second control system, a second instruction to decrease the delivered fuel ratio when the work is less than the predicted work.

8. The computer program product of claim 1, further comprising:
first applying, when at least a portion of the engine speed data corresponds to a steady-state engine speed, a correction to measured engine speed data based on engine inertia data to generate second engine speed data, wherein the range is between a compression start and an expansion end and wherein the work is calculated over the range;
adding the work as an entry to a variation table;
calculating a coefficient of variation based on the entries in the variation table; and
transmitting, to a third control system, an instruction based on a comparison of the coefficient of variation to an allowable range, the instruction being a first instruction which, when implemented by the third control system reduces the coefficient of variation when the coefficient of variation is larger than the allowable range, or a second instruction which, when implemented by the third control system, increases the coefficient of variation when the coefficient of variation is smaller than the allowable range.

9. The computer program product of claim 1, further comprising:
clearing the variation table after transmission of the instruction, wherein the transmitting occurs when a number of entries of the variation table is at least a predefined number.

10. The computer program product of claim 1, the first instruction comprising at least one of: reducing a spark advance, reducing exhaust gas recirculation, increasing a fuel input, and reducing a throttle, and
the second instruction comprising at least one of: increasing the spark advance, increasing the exhaust gas recirculation, reducing the fuel input, and increasing a throttle.

11. The computer program product of claim 1, wherein the engine speed data is acquired over a 2-stroke combustion cycle.

12. The computer program product of claim 1, wherein the engine speed data is acquired over a 4-stroke combustion cycle.

13. A computer program product comprising a non-transient, machine-readable medium storing instructions which, when executed by at least one programmable processor, cause the at least one programmable processor to perform operations comprising:
receiving, by the at least one programmable processor, engine speed data for an engine;
calculating, by the at least one programmable processor, a work corresponding to a component of the engine based on a change in the engine speed data over a range;
reading a predicted work value from a table based on an engine speed and first metric; and
transmitting, to a control system a value which, when implemented by the control system, is expected to result in a change to the calculated work for the component, the change expected to result from an investigative trial for seeking an improvement of an amount by which the calculated work exceeds the predicted work value.

14. A method for implementation by at least one programmable processor, the method comprising:
receiving, by the at least one programmable processor, engine speed data for an engine;
calculating, by the at least one programmable processor, a work corresponding to a component of the engine based on a change in the engine speed data over a range;
reading a predicted work value from a table based on an engine speed and first metric; and
transmitting, to a control system when the calculated work is not the predicted work value, a value which, when implemented by the control system, reduces a difference between the predicted work value and the calculated work for the component.

15-39. (canceled)

40. The computer program product of claim 13, the investigative trial comprising:
altering an operation of the component from a first operating state to a second operating state to effect a change in the engine speed;
storing data corresponding to the altering of the operation in the table when the altering increases the amount by which the calculated work value exceeds the predicted work value; and
returning the operation of the component to the first operating state when the altering does not increase the amount by which the calculated work value exceeds the predicted work value.

41. The computer program product of claim 41, the investigative trial further comprising sweeping operating parameters to map out an operating surface comprising a plurality of second operating states under a current engine configuration.

42. The computer program product of claim 41, the operating parameters comprising an engine speed.

43. The computer program product of claim 42, the operating parameters further comprising an injected fuel mass and an airflow.

44. The computer program product of claim 41, wherein the table is an expansion table characterizing the work done during an expansion stroke.

45. The computer program product of claim 41, wherein the table is a compression table characterizing an airflow profile of an engine.
